(19) United States
(12) Patent Application Publication
(10) Pub. No.: US 2016/0371544 A1
(43) Pub. Date: Dec. 22, 2016

(54) PHOTOVOLTAIC MEASUREMENT SYSTEM

(71) Applicant: Vivint Solar, Inc., Lehi, UT (US)

(72) Inventors: Willard S. MacDonald, Sebastopol, CA (US); Judd Reed, Sebastopol, CA (US); Caleb Austin, Sebastopol, CA (US); Mark McCall, Santa Rosa, CA (US); Roger L. Jungerman, Petaluma, CA (US)

(21) Appl. No.: 15/189,879

(22) Filed: Jun. 22, 2016

Related U.S. Application Data
(60) Provisional application No. 62/182,937, filed on Jun. 22, 2015.

(51) Int. Cl. G06K 9/00; G01B 11/26; G01W 1/12; G01B 11/02; H04N 5/232; H04N 5/247

(52) U.S. Cl. CPC G06K 9/00637; H04N 5/23238; H04N 5/247; G01W 1/12; G01B 11/02; G01B 11/26

(57) ABSTRACT

The present disclosure is directed to determining at least one attribute of a roof of a structure. A system may include at least one image capture device configured to capture two or more images of a photovoltaic installation site. The system may also include an image processing engine communicatively coupled to the at least one image capture device and configured to receive at least two images from the at least one image capture device and determine at least one attribute of the roof at the installation site based on the at least two received images.

### CROSS REFERENCE TO RELATED APPLICATIONS

This application claims benefit of and priority to U.S. Provisional Application No. 62/182,937, filed Jun. 22, 2015 and titled “Photovoltaic Measurement System,” and is incorporated herein by reference.

### TECHNICAL FIELD

This disclosure relates generally to measurement systems, and more specifically to measuring attributes of a roof of a structure at a photovoltaic system installation site.

### BRIEF SUMMARY

In one specific embodiment, a system includes at least one image capture device configured to capture two or more images of a photovoltaic installation site. The system further includes an image processing engine communicatively coupled to the at least one image capture device and configured to receive at least two images from the at least one image capture device and determine at least one attribute of a roof at the installation site based on the at least two images.

In another specific embodiment, a system includes at least one image capture device configured to capture two or more images of at least one of a roof of a structure and an area surrounding the roof. Moreover, the system includes an image processing engine communicatively coupled to the at least one image capture device and configured to receive at least two images from the at least one image capture device and determine at least one attribute of the roof.

According to other embodiments, the present disclosure includes methods for measuring at least one attribute of a roof of a structure. Various embodiments of such a method may include receiving a plurality of images, wherein each image includes at least one of a feature associated with the roof, one or more obstructions surrounding the roof, a fiducial or other device in the vicinity of a roof. In addition, the method may include modeling a shape of the roof and/or one or more obstructions surrounding the roof based upon a position of the feature in a first image of the plurality of images and a position of the feature in at least a second image of the plurality of images.

In accordance with another embodiment, a method includes receiving a plurality of images associated with a roof of a structure. Furthermore, the method includes determining at least one attribute of the roof based on at least two images of the plurality of received images.

Yet another embodiment of the present disclosure comprises a computer-readable media storage storing instructions that when executed by a processor cause the processor to perform instructions in accordance with one or more embodiments described herein.

Other aspects, as well as features and advantages of various aspects, of the present disclosure will become apparent to those of skill in the art through consideration of the ensuing description, the accompanying drawings and the appended claims.

### BRIEF DESCRIPTION OF THE DRAWINGS

FIG. 1A depicts a system, according to an embodiment of the present disclosure;

FIGS. 1B-1D are illustrations depicting adjustment of a modeled position of a camera, adjustment of a modeled orientation of camera, and adjustment of a modeled position of a feature, respectively, in accordance with an embodiment of the present disclosure;

FIG. 2 illustrates an image capture device including a pole and configured to capture one or more images of an installation site, according to an embodiment of the present disclosure;

FIG. 3 depicts another illustration of an image capture device including a pole, in accordance with an embodiment of the present disclosure;

FIG. 4 is yet another illustration of an image capture device, in accordance with an embodiment of the present disclosure;

FIG. 5 depicts an image capture device including a camera and at least one mirror, in accordance with an embodiment of the present disclosure;

FIG. 6 illustrates an image capture device including an aircraft and a camera, according to an embodiment of the present disclosure;

FIG. 7 depicts an image capture device including a counter weight, according to an embodiment of the present disclosure;

FIG. 8 illustrates an embodiment of an image capture device including a stabilization device, according to an embodiment of the present disclosure;

FIG. 9 illustrates another embodiment of an image capture device including a stabilization device, in accordance with an embodiment of the present disclosure;

FIG. 10 is a flowchart depicting a method, in accordance with an embodiment of the present disclosure; and

FIG. 11 is a flowchart depicting another method, according to an embodiment of the present disclosure.

### DETAILED DESCRIPTION

Referring in general to the accompanying drawings, various embodiments are illustrated to show the structure and methods for a measurement system. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Solar photovoltaic (PV) cells use light energy (photons) from the sun to generate electricity through a PV effect. A PV solar module includes PV cells mounted behind glass and may include a frame at least partially surrounding the edges of the cells and glass. A PV system, which may include a plurality of solar modules and various other electrical components, may be used to generate and supply electricity in utility, commercial and residential applications. The soft-costs of installing a PV system (i.e., costs excluding the cost of the modules, inverters, and other equipment) can be more than half of the entire installation cost (e.g., more than 65% of the total cost of the installation). A large portion of the soft-costs is labor costs, including the cost of injury and accidents and workman's compensation insurance.

As will be appreciated, portions of a PV system, including at least one solar module, may be installed on a roof of a structure (e.g., a residential or a commercial structure). A conventional approach to measuring attributes of a roof (e.g., dimensions of the roof, a pitch of the roof, and shading of the roof) includes traveling to a site of the structure, climbing on the roof, and measuring the dimensions of the roof with a tape measure, the pitch of the roof with a pitch gauge, and the shading of the roof with a measurement device, such as SunEye provided by Solmetric Corp. of Sebastopol, Calif. As will be understood by a person having ordinary skill in the art, climbing on a roof to determine these attributes requires not only a ladder, but also, the Occupational Safety and Health Administration (OSHA) requires safety equipment including a harness, a safety rope, and an anchor, which must be attached to the roof, typically with nails or screws. After a site survey is complete, the anchor must be removed and any holes remaining in the roof must be patched. Furthermore, the company employing the person climbing on the roof must carry workman's compensation insurance that is typically significantly higher for roof workers than for employees that do not climb on a roof. Traveling to the site requires a vehicle and driving time. All of these requirements add significant cost to the site survey process and contribute to the overall cost of a PV system.

Various embodiments of the disclosure are related to determining physical attributes of a roof without climbing on the roof and possibly without visiting an installation site. The physical attributes may include, for example only, dimensions of the roof, a height of the roof, an orientation of the roof, a pitch of the roof, and shading of the roof.

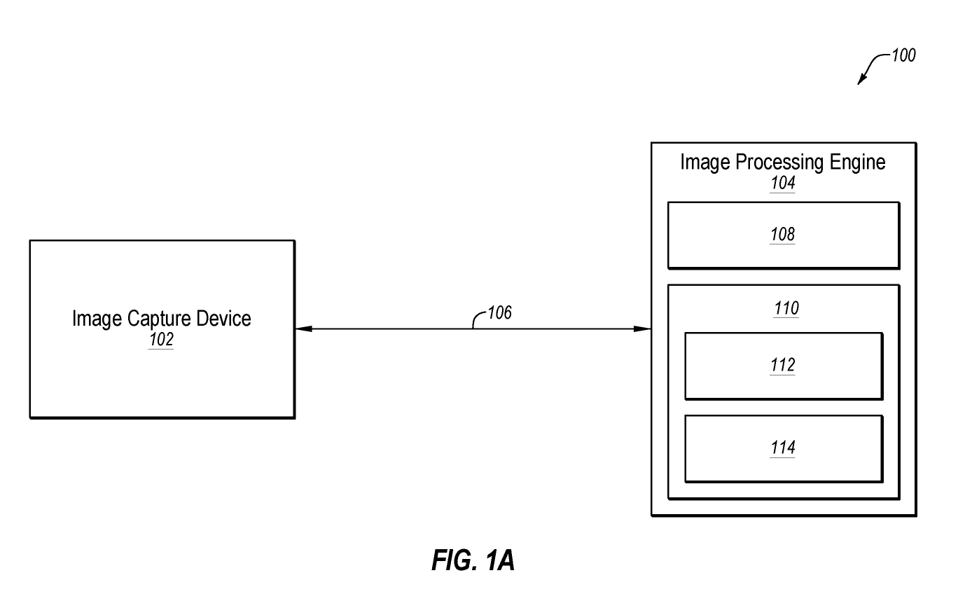

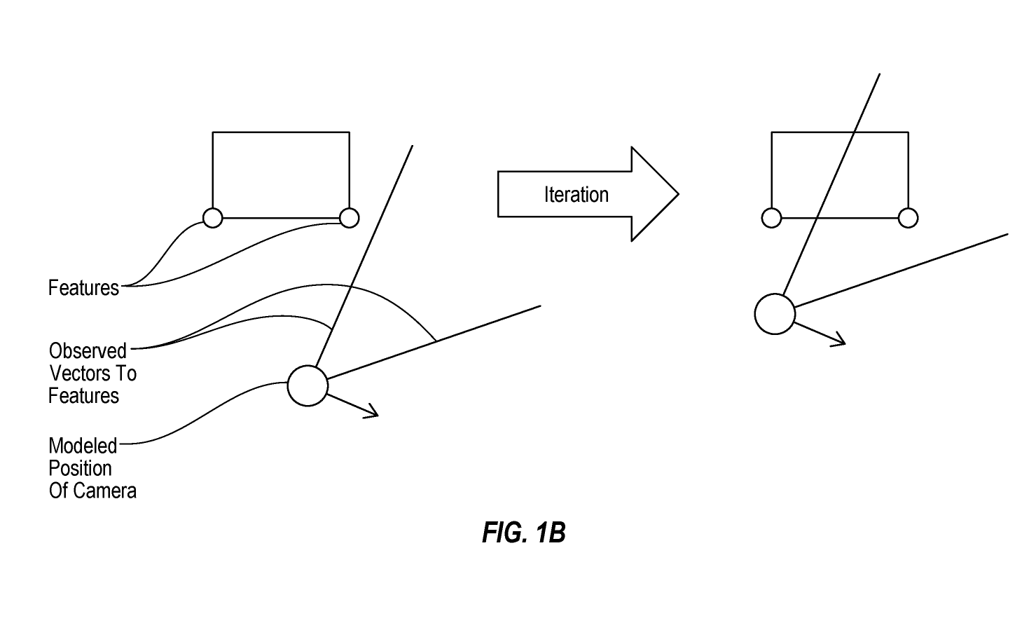

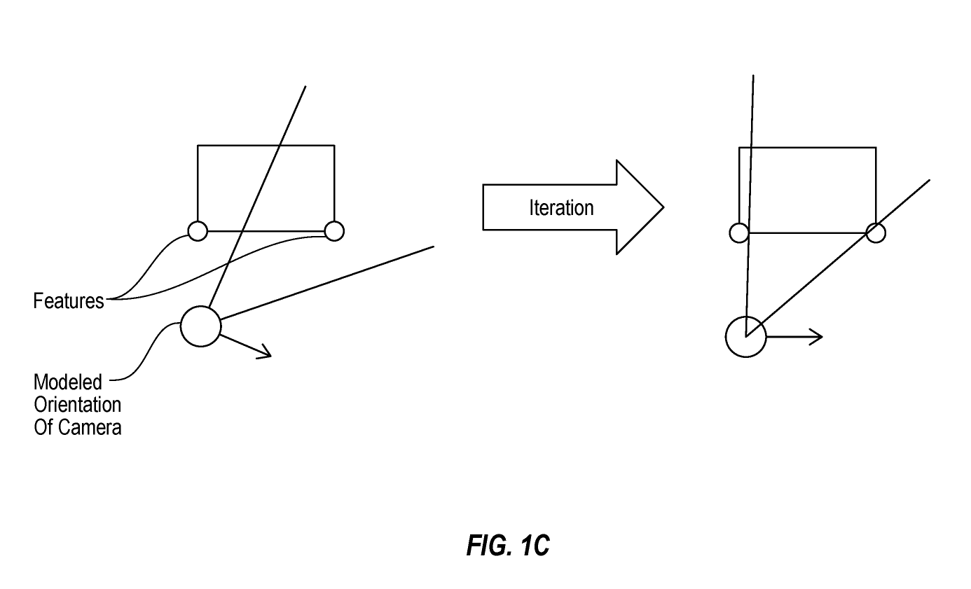

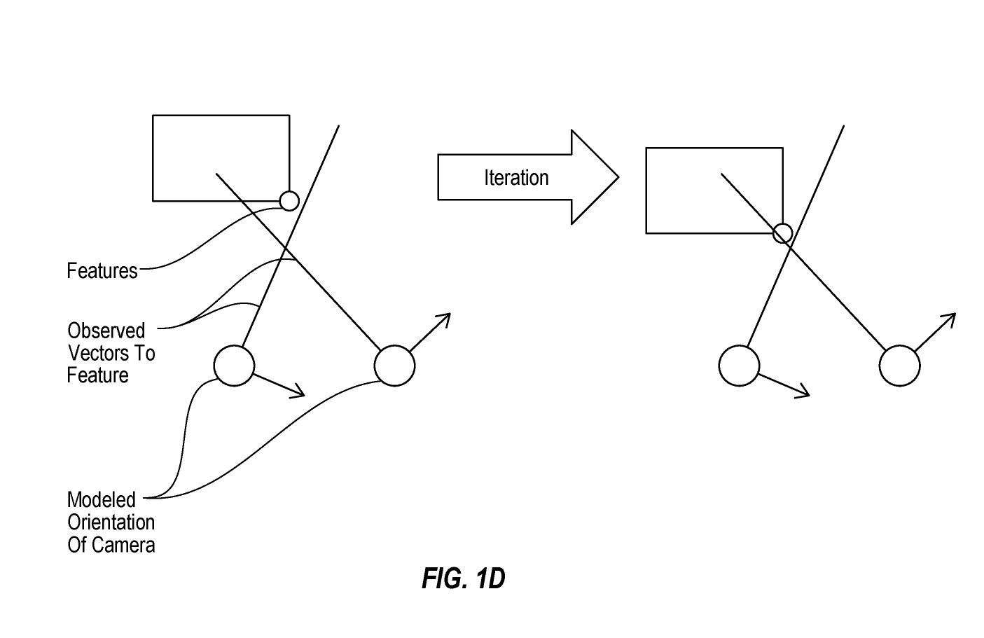

With reference to FIG. 1, according to one embodiment of the present disclosure, a system 100 includes at least one image capture device (ICD) 102 configured to capture one or more images of a roof, an area surrounding the roof, or a combination thereof. Image capture device 102 may be configured to enable a user to capture the one more images without requiring the user to climb on the roof. Image capture device 102 may further be configured to convey the one or more images (i.e., via a wired and/or wireless connection).

By way of example, the at least one image capture device 102 may comprise a camera. More specifically, the one or more image capture devices 102 may include at least one camera including, for example, a narrow field-of-view (“FOV”) lens (e.g. 60 degree FOV), a fisheye lens (e.g. 180 degree FOV), a spherical lens (e.g. 360 degree FOV), a panoramic lens, or any other FOV. The one or more image capture devices 102 may comprise, for example, handheld devices, pole-mounted devices, satellite-mounted devices, manned aircraft-mounted devices, and/or un-manned aircraft-mounted devices (e.g., drone). It is noted that the one or more image capture devices 102 may be used in any suitable manner to capture images of the roof and/or the roof's surroundings.

System 100 may further include an image processing engine 104 communicatively coupled to image capture device 102 via a connection 106, which may comprise a wired connection, a wireless connection, or a combination thereof. According to one embodiment, image processing engine 104 may receive as inputs two or more images of a roof, an area surrounding the roof, or a combination thereof. The two or more images may be from one or more image capture devices (e.g., image capture device 102). Further, image processing engine 104 may be configured to determine, based on the two or more images, physical attributes of a roof, such as, for example only, dimensions of the roof, the height of the roof, the orientation of the roof, the pitch of the roof, and solar access (i.e., shading) of the roof. One act in determining these attributes may be the identification of one or more features in the images. Features may be, for example, features of the roof, such as the south east corner of the roof, or the edge of a vent pipe. Alternatively, or in addition, features may include features of the surrounding area such as the neighbor's roof, or they may be artificially (or intentionally) placed features such as a fiducial, stake in the ground, or other device positioned (e.g., by the user) in proximity to the roof. The approximate position (or location) of each feature may be provided by image processing engine 104 as determined from a series of acts that may include user input, image recognition, iteration, and regression. In this context, position means the modeled x, y, and z coordinates of a point in space. Typically, these will be east, north, and height offsets from an arbitrary reference point. A precision estimate is also associated with each feature position. A complete survey may require a point at each vertex of each roof section outline and points to locate roof penetrations, other architectural features, obstructions around the roof, and possibly reference points.

An observation (or observed position) is the identification of the pixel coordinates in an image where a specified feature point is observed. This information may be provided by, for example, a user or a survey analyst, or it may be determined automatically. Like feature points, observations may include precision estimates. However, these confidence intervals have angular dimension.

Typically, each feature point may include at least two observations (i.e. from one or more cameras). A third observation may be required to assess the precision of the point's location. Additional observations from different perspectives may help reduce point location uncertainty. Typically, each image includes a minimum of three or four features for the camera position and orientation to be calculated. A fourth or fifth feature point may be required to assess camera position and orientation precisions, and in general observations of additional points may help to improve that precision.

The precise position of a feature point may be where the rays (sight lines) of all observations of that point intersect. If a point is observed in only one image, its position may be calculated if it is constrained to a known plane. If multiple observations of the feature point exist, a regression may be performed to find the position where the sum of squares of minimum distances to rays is minimized. When three or more rays are available, the position and an estimated precision of that point may be calculated. Precision may be reduced proportional to the amount multiple observation rays fail to intersect at a single point. The distances from the feature point to the camera viewpoints associated with each ray may also contribute uncertainty. Furthermore, the point uncertainty may be increased by uncertainties associated with the observation ray equations.

The above describes computation of feature point positions from observations assuming known sight lines derived from known camera positions and orientations combined with known ray direction from the cameras (typically camera positions and orientations will not be known, but will have a modeled (or estimated) location that is refined through iterations of the algorithm). Conversely, if feature point positions are assumed, known camera position and orientation can be computed from the relative positions of multiple observations within the scene. The observation of a feature implies a ray from the camera's view point (i.e. position) toward the feature's position. Two feature observations in the same scene may be separated by an angle determinable from the relative positions of the observations in the scene. When camera geometry is fixed and well known, the precision of this angle may be limited by how precisely the points can be seen in the scene.

In one specific embodiment, image processing engine 104 may be configured to determine a three-dimensional (3D) model of a roof by identifying features in different images automatically, via user input, or both. Examples of features may include, for example, vertices of one or more roof sections, vent pipes, chimneys, or dormers. As a specific example, image processing engine 104 may be configured to locate the northeast corner of the roof in each of the images using image recognition techniques, or the user may click on the northeast corner of the roof in each of at least two or more of the images. Image processing engine 104 may further be configured to determine a location and orientation of the at least one image capture device 102 relative to the roof, area surrounding the roof, the earth, or a combination of these, or within the 3D model.

In one embodiment, image processing engine 104 may be configured to begin with an initial (arbitrary) camera position and orientation. After features corresponding to known locations in the images are identified, image processing engine 104 may be configured to refine positions and orientations of the at least one image capture device 102 and, more specifically, at least one camera of image capture device 102 at the time the image(s) are captured. For example, camera positions may be refined by considering an apparent angle between observed feature pairs. When two features a known distance (‘s’) apart are observed within one image separated by a specific angle (‘a’), the two points and the camera lie on the perimeter of a circle having a radius r=s/(2*sin(a)). The set of all possible circles of that radius which pass through the two observed features is the surface of a spindle torus with symmetry about the line connecting the two features and self-intersection points at the two features.

Typically the camera is located at some point on this surface. By considering the approximate intersection of a plurality of such surfaces resulting from consideration of multiple feature pairs, the most probable camera positions(s) (e.g. relative to the features, a world, or a model coordinate system) may be determined. The location of each camera may be found by minimizing the square of the distance to each of the toroidal surfaces. Once the location(s) of the camera(s) are established, the camera orientation (e.g. relative to a world or model coordinate system) may also be estimated by image processing engine 104, for example, by establishing rays (i.e. lines of sight or vectors) from the camera position to the modeled (i.e. current best estimate) feature position and to the observed (i.e. based on camera image) feature positions, and by finding the refined camera orientation that results in the smallest sum of the square of the angles between the two rays. Camera position and orientation and feature positions may be found iteratively by repeating the steps above to minimize errors. Alternatively, regression may be used.

Positions of features are adjusted and then used to adjust positions and orientations of cameras. Positions and orientations of cameras may then be used to adjust positions of features. This process is repeated until the precisions converge or until some other criteria (e.g. number of iterations) is achieved. It is noted that it is not required for image processing engine 104 to receive location or orientation of the at least one camera of image capture device 102 as an input. Rather, image processing engine 104 may determine the location and/or orientation from the content of the two or more images. Other embodiments of image processing engine 104 may be configured to determine camera locations and orientations through the use of other iterative or regression techniques.

In another embodiment, image processing engine 104 may be configured to establish the positions and orientations of the cameras and the features. More specifically, an initial estimate of the modeled positions of features and initial arbitrary modeled positions and orientations of cameras (i.e. at times of image captures) may be determined. For each image, the modeled position of the camera may be adjusted, as shown in FIG. 1B. This may include determining the observed vectors between the camera and the features, calculating the distances between the modeled positions of the features and the observed vector for each feature, and adjusting the modeled position of the camera to minimize the root-mean-square of the distances.

In addition, for each image, the modeled orientation of the camera may be adjusted, as shown in FIG. 1C. This may include determining the observed locations of features in the image and determine the observed vector angles to every feature based on the orientation of the camera and the pixel positions of the features in the image, calculating the modeled vector angle between the position of the camera and the positions of each feature, and adjusting the modeled orientation of the camera to minimize the root-mean-square of the differences between the observed vector angles and the modeled vector angles.

Further, for each feature, the modeled position of the feature may be adjusted, as shown in FIG. 1D. This may include determining the observed vectors between the cameras and the feature, calculating the distance between the feature and each observed vector, and adjusting the modeled position of the feature to minimize the root-mean-square of the distances.

Additionally, the above disclosed acts of 1) for each image, adjusting the modeled position of the camera, 2) for each image, adjusting the modeled orientation of the camera, and 3) for each feature, adjusting the modeled position of the feature may be repeated until adjustments are sufficiently small for the desired accuracy of the model.

Further, image processing engine 104 may be configured to determine relative dimensions of roof edges, vent pipes, etc. as the distances between features. Once the relative dimensions are determined, the absolute dimensions may be determined by scaling the relative model. A scaling factor for the dimensional measurements may be obtained by knowing the scaling of at least one of the images (e.g., feet-per-pixel), knowing at least one length appearing in at least one of the images, and/or by knowing the relative positions between two or more of the images (i.e., the relative positions of the at least one image capture device 102 at the time the images were captured).

An image capture device, which operates at an installation site, may typically have better resolution than an image capture device that uses aerial imagery. Hence, relatively small features on the roof, such as small vent pipes, may be better captured with an on-site image capture device. Knowledge of the location of these relatively small features may be used to determine locations that must be avoided in designing a proposed solar module layout and to avoid the possibly significant shading effects of these features. In addition, the location and height of these obstructions may be used to determine the as-built impact of the obstruction shading on solar production.

The azimuth orientation of the roof (i.e., the angle of the roof edges relative to true North), may be obtained by a known orientation of at least one image. This may be obtained from aerial or satellite imagery acquired along with orientation data that may be provided as metadata along with the image. This orientation information may be obtained, for example, from a compass or a global positioning system (GPS) used together with image capture device 102 that acquires the image. Alternatively, for images taken at the installation site, the orientation and position may be determined from a known orientation of image capture device 102, for example, via an electronic compass, a manual compass that is observable in the image, and/or manual entry by the user at the time the image is taken. The orientation of the roof may be needed to calculate the position of the sun relative to the roof surface at times throughout the evaluation interval. Image processing engine 104 may further be configured to determine orientation using the observation of shadows in one or more images acquired at a known date and time, or from observation of distant landmarks at known locations in one or more of the images.

Image processing engine 104 may also be configured to determine a 3D model of solar obstructions surrounding the roof by determining sizes, shapes, and/or locations of the obstructions following a similar process to the one described above for the roof model. For example, image processing engine 104 may locate a top of a tree proximate the southeast corner of the roof in each of the images using image recognition techniques, and/or the user may click on the top of the tree in one or more of the images. Image processing engine 104 may then extract the locations and dimensions of the obstructions. The scaling factor may be used again. Once the obstructions and roof are modeled, the shadows may be simulated and the solar access (i.e., shading) may be determined.

Further, image processing engine 104 may be configured to determine the shading at each of the image capture device locations by identifying the skyline and calculating the solar access, as described in U.S. Pat. No. 7,873,490 (e.g., image capture device 102 may comprise a fish eye camera pointing approximately vertically (i.e., approximately perpendicular to the earth's surface) or it may be the upper hemisphere of a spherical camera). The orientation of image capture device 102 and, more specifically, a camera of image capture device 102, may be determined as described above. The skyline may be obtained at several positions around the perimeter of the roof, typically including the corners of the roof. Images may be obtained in a plane as close as possible to that of the plane in which the solar modules will be installed (e.g., 3-6 inches above the plane of the roof for residential systems). In this way, the shading effect at the solar module location may be accurately determined.

From the position of the roof vertices, the tilt (or pitch) of each roof section may be determined. Both the tilt and azimuth orientation of the roof plane may be determined to evaluate the shading effect on solar PV production of one or more solar modules. In one embodiment, the tilt may be determined from the 3D position of the vertices of the roof section. In another embodiment, the tilt of the roof section may be determined by comparing the angle of a roof section in an image to a reference line of a known tilt angle. To determine the angle of the reference line, the tilt of image capture device 102 that captured the image may be used. The tilt of image capture device 102 may be determined from electronic accelerometers, from triangulation to points in the image with known positions, or both. For example, points on an eve of a roof are known to be at the same elevation and, thus, may be used to determine the image capture device tilt. In another example, points on the ridge of the roof are known to be at the same elevation and may be used to determine the image capture device tilt.

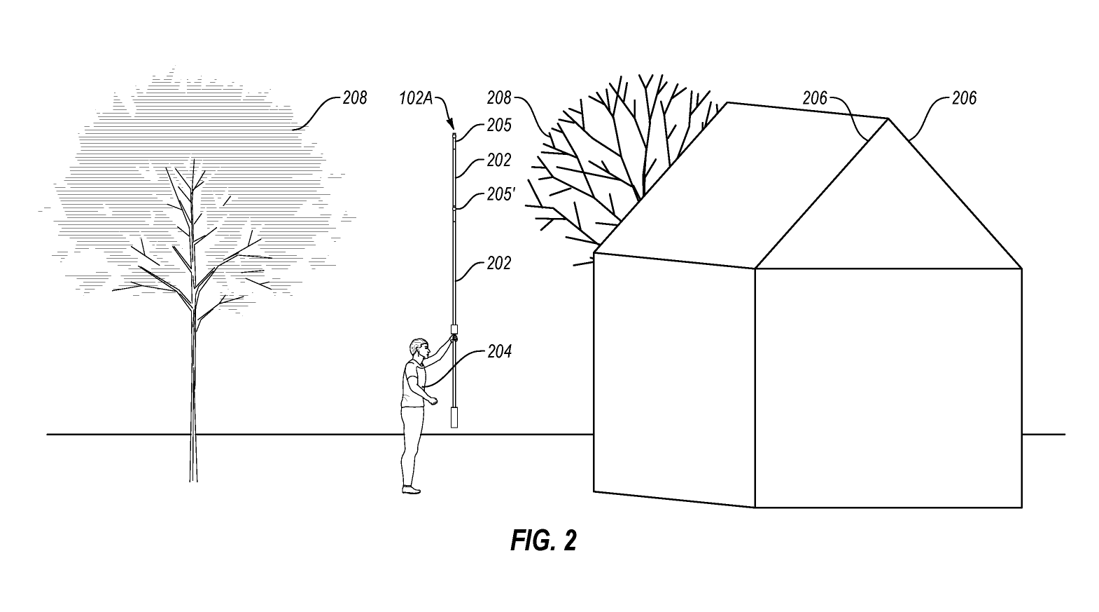

In one embodiment, image capture device 102 may capture a panoramic image, which may have a vertical FOV of, for example only, 90 degrees, and a horizontal FOV of, for example only, 360 degrees. The panoramic image may be captured with a panoramic camera (e.g., Ricoh Theta produced by Ricoh Americas Corporation of Phoenix, Ariz.) mounted on a pole 202 (see FIG. 2). With continued reference to FIG. 2, a user 204 may stand on the ground and position at least a portion of an image capture device 102A above the plane of a section of a roof 206 (e.g. above an eve) via pole 202 to capture a panoramic image that includes roof 206 as well as trees 208, other buildings (not shown in FIG. 2), or other solar obstructions on the horizon surrounding the roof. User 204 may capture two or more images at different locations around roof 206 by moving image capture device 102A and triggering a camera 205. Camera 205 may be triggered, for example, by pressing a button on a smart phone or other device (not shown in FIG. 2) in communication (i.e., wired or wireless communication) with camera 205. It is noted that a panoramic camera has the advantage over one or more narrower FOV cameras in that it may capture an image of a roof and the roofs surroundings in a single image, whereas a narrower FOV camera may require two or more images to capture the same information. A panoramic camera may include, for example, a back-to-back fisheye camera (e.g., Ricoh Theta), three or more narrow FOV cameras, one or more narrow FOV cameras that are rotated to sweep out a panoramic image, or a spherical camera.

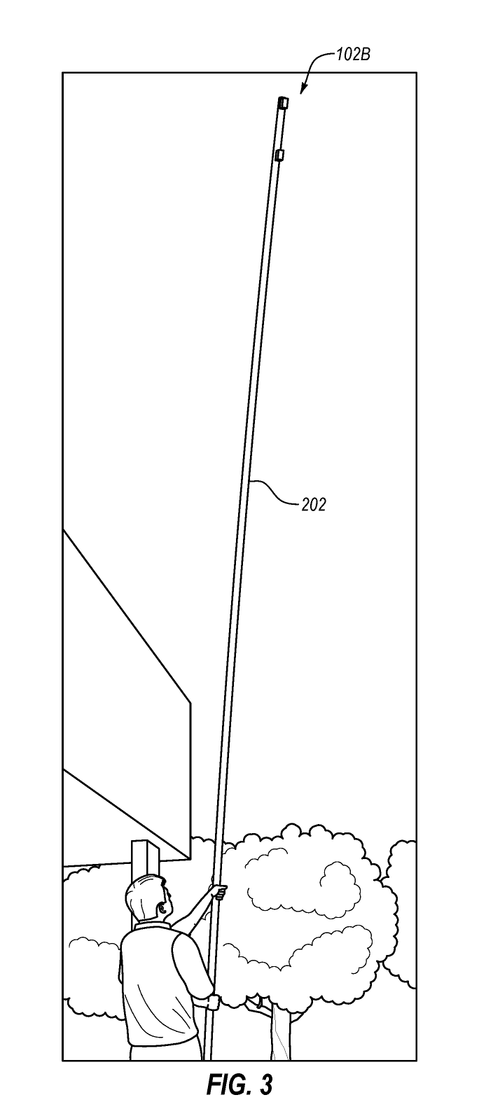

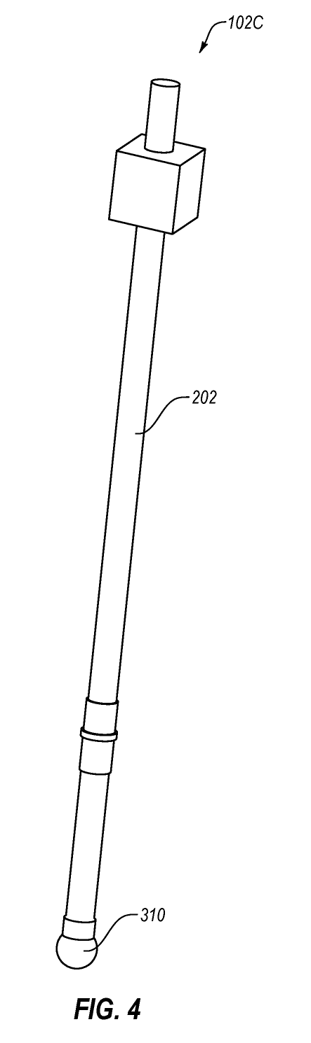

FIGS. 3 and 4 are additional illustrations of image capture devices 102B and 102C, respectively, including pole 202. Pole 202 may be made of, for example only, carbon fiber, fiber glass, aluminum, plastic, etc. Pole 202 may comprise a non-conducting material (e.g., fiber glass) so that if it touches an un-insulated power line, a user will not be exposed to high voltage. Pole 202 may be extendable to, for example, 15 or more feet above the ground to rise above a single story roof plane or may be extendable to, for example, 30 or more feet above the ground to rise above a two story roof plane.

In one embodiment, a scaling factor is a reference of known length, such as a yard stick, placed on the roof and appearing in at least one of the images. Alternatively, the scaling factor may be extracted from one or more of the images directly if the one or more images are scaled images. For example, aerial imagery available from United States Geological Survey (“USGS”) or other sources may include a pixel-to-feet scaling factor. When one or more of these images of the same roof and/or surrounding objects is combined with one or more other images from an on-site image capture device it can provide the scaling factor. The scaling factor may be refined by processing two or more approximate edge lengths in one or more scaled aerial photos. For example, an average scaling factor may provide increased accuracy.

With specific reference to FIG. 2, in another embodiment, image capture device 102A may include two cameras 205 and 205′ (e.g., panoramic cameras) mounted to pole 202 at a known distance apart (e.g., 3 feet). Cameras 205 and 205′ may be triggered substantially simultaneous with each other. With two cameras at known distances from each other, the scaling factor may be determined by identifying the same linear feature (e.g., a roof edge) in both images from the two cameras.

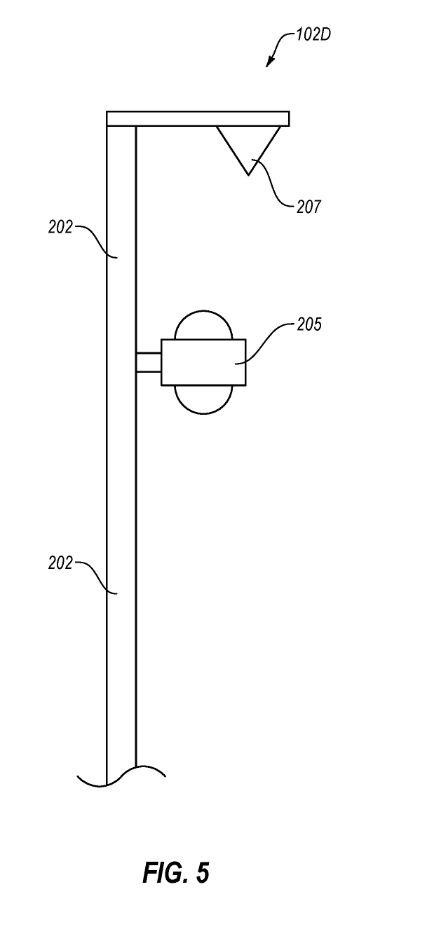

In another embodiment, image capture device 102 may include a single camera having a FOV and one or more mirrors mounted to pole 202 at known distances from the camera. FIG. 5 illustrates an embodiment of an image capture device 102D including pole 202, camera 205 and one or more mirrors (e.g. a conical mirror) 207. For example, camera 205 may comprise a spherical camera having a vertical FOV of 360 degrees and a horizontal FOV of 360 degrees (e.g. Ricoh Theta). One or more mirrors 207 may be within the field of view of camera 205. With camera 205 and one or more mirrors 207 at known distances from each other, the scaling factor may be determined by identifying the same linear feature (e.g., a roof edge) in the image captured directly by camera 205 and the images of the one or more mirrors 207 captured by camera 205. One or more mirrors 207 may make use of part of the FOV of camera 205 that may not otherwise be used. For example, a spherical camera may capture an image of the sky as well as the ground. A mirror placed above camera 205 and/or below it may then utilize pixels that would otherwise have low value to an image processing engine. One or more mirrors 207 may be spherical, semi-spherical, conical, flat, concave, convex, or any other suitable shape.

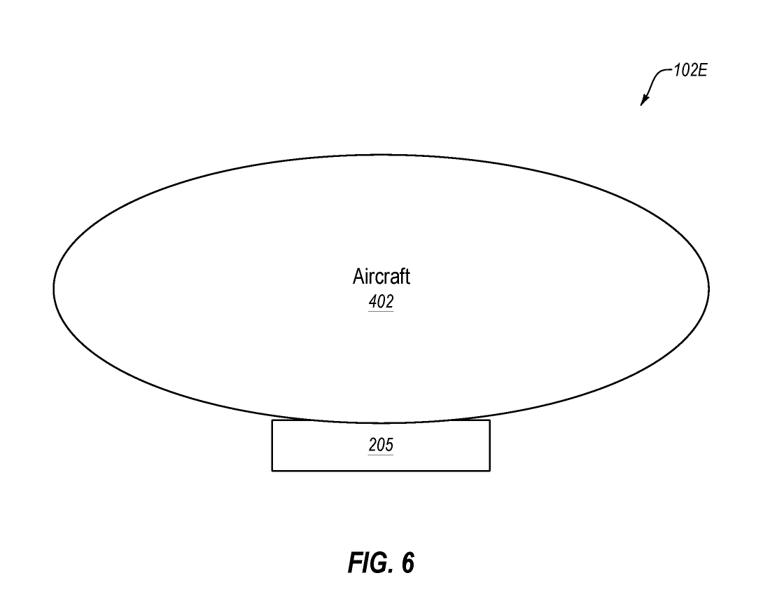

With reference to FIG. 6, in another embodiment, an image capture device 102E may comprise an aircraft, such as an un-manned aircraft or drone (e.g., a quadcopter such as a DJI Phantom drone sold by DJI of Shenzhen, China) coupled to camera 205. An un-manned aircraft may be controlled by a computer program and/or a user to fly around the installation site capturing images of the roof and/or surrounding areas. In another embodiment, image capture device 102E may include a tethered drone, such as a Fotokite produced by Perspective Robotics of Zurich, Switzerland. The tethered drone may be moved around the site by a user holding a tether, such as a cable. The drone may capture images of the roof and surrounding area. A tethered drone has the advantage of being currently allowed by the FAA for commercial use (un-tether drones are only allowed for very specific applications). Furthermore, it is likely to be more stable in high winds and less likely to crash.

In an embodiment wherein image capture device 102 comprises a drone (e.g., image capture device 102E), the scaling factor may come from an aerial image (e.g., imagery from USGS) that is included in the set of images. Alternatively, or in combination, image capture device 102 may be configured to track the location and orientation of the drone (or the location and orientation of the camera on the drone) with, for example, one or more of a GPS satellite, an accelerometer, a gyroscope (“gyro”), a compass, an optical position tracking device, and a dead reckoning device. This location and orientation information may be useful by image processing engine 104 and may provide the scaling factor. The location of the drone when capturing a single image may not be known to a sufficient degree of accuracy. For example, GPS is typically accurate to +/−9 feet, and dead reckoning based on accelerometers or gyros suffers from noise and drift. To address any inaccuracy in the location tracking of the drone, a refined scaling factor may be calculated from two or more approximate locations of the drone. For example, the average of multiple distances between multiple drone locations may be utilized. The iterative and regressive approach to determining the location and orientation of the image capture device described above may also be used to determine the location and orientation of the drone (or camera on the drone).

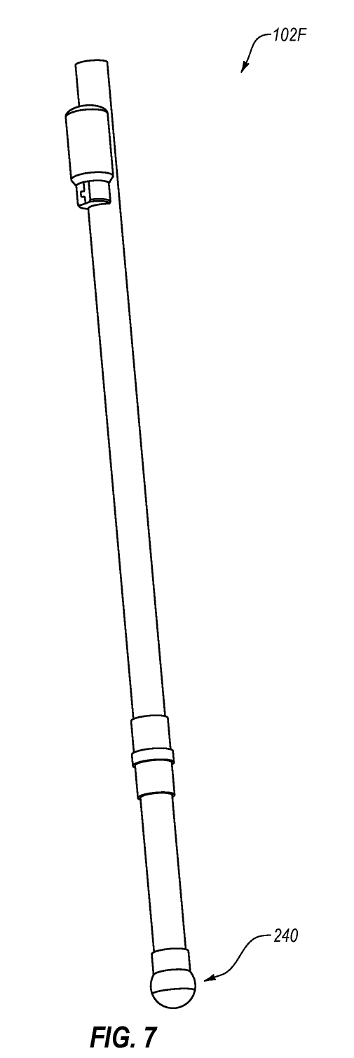

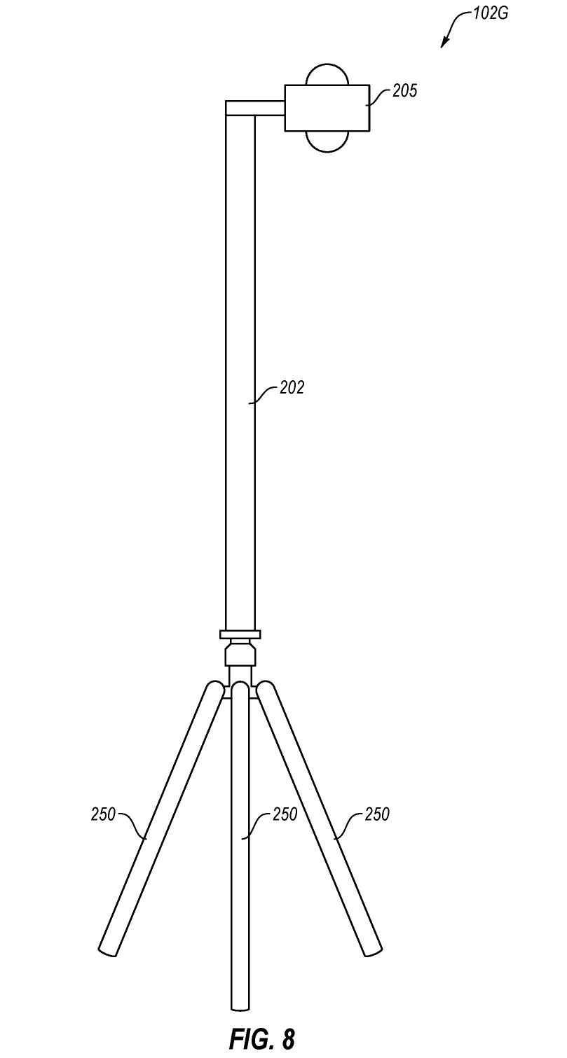

As will be appreciated, a pole, such as pole 202, thirty feet or more in length, for example, can be challenging to manipulate for a user. According to various embodiments, image capture device 102 may include a pole stabilization device. For example, with reference to FIG. 7, image capture device 102F may include a counter weight 240 attached to pole 202 and configured to lower the center of mass of pole 202 (i.e., during use) than it would be otherwise. It may be preferable for the center of mass of pole 202 (plus counter weight) to be at, or lower than, the height the user can reach (e.g., approximately 6 feet). According to one embodiment, as illustrated in FIG. 8, an image capture device 102G may include a pole stabilization device that may include one or more fixed or foldable legs (e.g., like on a camera tripod) 250 that may help prevent pole 202 from falling over. In another embodiment, the center of mass of pole 202 may be below the center of radius of a round foot such that the pole is self-righting.

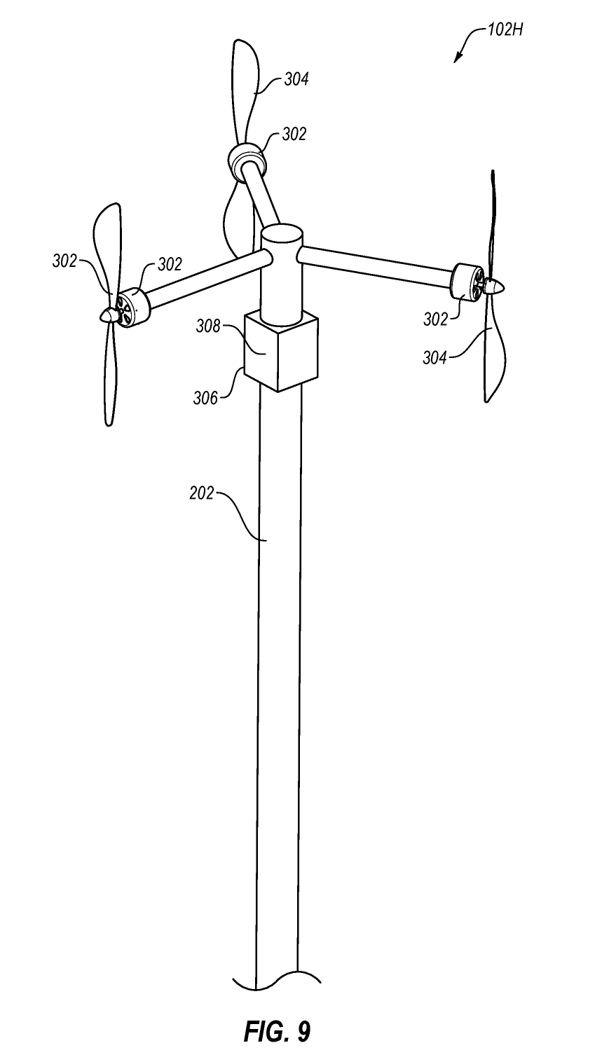

A long, light-weight pole may have a significant amount of sway at the tip. In another embodiment, pole 202 may include a pole stabilization device in which the end of pole 202 may be actively stabilized with a feedback servo loop. For example, as illustrated in FIG. 9, an image capture device 102H (e.g., including one or more cameras) may include one or more motors 302 with propellers 304 that may be controlled by a controller 306 receiving acceleration information from one or more accelerometers 308. In one example, the active control system may have a plurality (e.g., three) of motors 302 with propellers 304 spaced equally around a tip of pole 202 with the axel of motors 302 pointing radially out from the tip perpendicular to pole 202. Pole 202 may further include an accelerometer 308 oriented in each of two orthogonal directions within the plane perpendicular to pole 202. As the tip of pole 202 sways in one direction, accelerometers 308 may sense it, and controller 306 may generate a signal to motors 302 to increase the thrust in the direction opposite to the detected acceleration, hence counteracting the sway. The acceleration may further be integrated such that controller 306 may track the position of the tip of pole 202 and may counteract not just the acceleration but the translation. An additional pair of accelerometers may be mounted at the base of the pole so that lateral movement that is initiated by the user such as re-locating the pole elsewhere around the site is not counteracted by controller 306.

In one embodiment, image capture device 102 may include a ball, a balloon, pneumatic, rubber, or otherwise compliant or bouncy member 310 (see e.g., image capture device 102C of FIG. 4) at a base of pole 202 to provide friction to the ground to help a user stabilize pole 202 and to protect pole 202 if dropped on its end. Alternatively, image capture device 102 may include a wheel at the base of pole 202 to provide friction to the ground in the direction parallel to the axel of the wheel as well as ease with transportation of pole 202 from location to location around the installation site or to or from the installation site.

In another embodiment, image capture device 102 (see e.g., FIG. 6) may capture aerial images by satellite or airplane, such as those used by the USGS and others sources. These images are typically available with foot-per-pixel scale factors. They may also be available from at least four perspectives for a given site, including, for example, orthonormal (i.e., direct overhead), and oblique from each of four cardinal directions. This embodiment may have the advantage of not requiring a person to physically visit the installation site, thus saving cost. The scaling factor may be refined by processing two or more approximate edge lengths in one or more aerial photos. For example, an average scaling factor may be calculated that is more accurate than a single one. When other metadata associated with aerial imagery is available, such as the location and orientation of the image capture device (i.e., at least one camera of the image capture device) at the time the images are captured, it may be used instead of the iterative or regressive process described above for determining location and orientation of the one or more image capture devices.

In another embodiment, image capture device 102 may include a camera mounted on a tripod or other device that rigidly holds the camera in a fixed position. The camera may be oriented at a known orientation based on, for example, a compass and/or inclinometer. The camera may further be positioned at a known location, for example, based on measurements from known reference points or GPS. In this embodiment, the camera position and orientation may be controlled and/or known precisely by a user and communicated to image processing engine 104. This may make identifying the position and orientation of the camera by the image processing engine 104 unnecessary.

It is noted that image capture device 102 may include any combination of the embodiments described above. In general, image processing engine 104 can accept images from a variety of sources. For example, the set of images may include one or more aerial images (e.g., from the USGS) and one or more images captured by a panoramic image capture device (e.g., Ricoh Theta) on a pole. When aerial image metadata is available, such as the location and orientation of the aerial image capture device, it may be used to improve the process described above for determining location and orientation of the one or more image capture devices at the time the images are captured.

It is further noted that image capture device 102 may be used by a user standing on the ground, standing on a ladder, standing on the roof, inside an aircraft, etc. In general, image capture device 102 may be used anywhere that enables image capture device 102 to capture an image of at least part of the roof, at least part of the solar obstructions around the roof, or both.

With reference again to FIG. 1, image processing engine 104 may comprise a processor 108 and memory 110. Memory 110 may include an application program 112 and data 114, which may comprise stored data (e.g., images). Generally, processor 108 may operate under control of an operating system stored in memory 110, and interface with a user to accept inputs and commands and to present outputs. Processor 108 may also implement a compiler (not shown) which allows one or more application programs 112 written in a programming language to be translated into processor readable code. In one embodiment, instructions implementing application program 112 may be tangibly embodied in a computer-readable medium. Further, application program 112 may include instructions which, when read and executed by processor 108, may cause processor 108 to perform the steps necessary to implement and/or use embodiments of the present disclosure. It is noted that application program 112 and/or operating instructions may also be tangibly embodied in memory 110, thereby making a computer program product or article of manufacture according to an embodiment the present disclosure. As such, the term “application program” as used herein is intended to encompass a computer program accessible from any computer readable device or media. Furthermore, portions of application program 112 may be distributed such that some of application program 112 may be included on a computer readable media within image processing engine 104, and some of application program 112 may be included in another electronic device (e.g., image capture device 102). Furthermore, application program 112 may run partially or entirely on a smartphone or remote server.

Embodiments of the present disclosure may be configured to build up a data set representing a roof and/or surrounding obstructions. To fully measure the one or more roof sections of interest and to fully capture the shading of those roof sections requires a minimum coverage of images. Image processing engine 104 may direct the image capture device or user to capture one or more additional images at specific approximate locations in order to fill out or complete the data set.

As described herein, the present disclosure may include an image capture device in signal communication with an image processing engine configured to determine the solar access of a predetermined location. However, the present disclosure does not require the position or the orientation of the image capture device (i.e., at least one camera of the image capture device) to be known or measured at the time that the images are captured. The iterative or regressive approach described earlier may determine the orientation and location from the imagery. Furthermore, embodiments of the present disclosure may be enabled to determine other aspects of the roof besides just solar access, including, for example only, dimensions, pitch, and orientation. It is noted that embodiments of the present disclosure may obtain images with a real-world image capture device of a real-world horizon, as opposed to with a virtual image capture device of a virtual horizon.

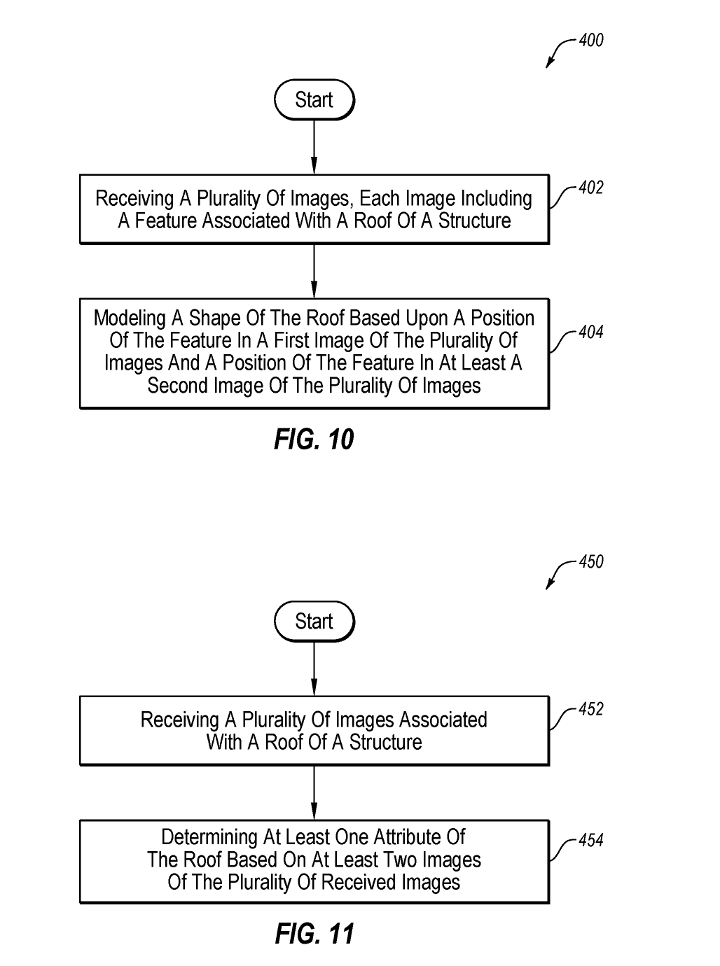

FIG. 10 is a flowchart of a method 400, according to an embodiment of the present disclosure. Method 400 may include receiving a plurality of images, each image including one or more features associated with a roof of a structure (depicted by act 402). Method 400 may further include modeling a shape of the roof based upon a position of the feature in a first image of the plurality of images and a position of the feature in at least a second image of the plurality of images (depicted by act 404).

Modifications, additions, or omissions may be made to method 400 without departing from the scope of the present disclosure. For example, the operations of method 400 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 11 is a flowchart of a method 450, according to another embodiment of the present disclosure. Method 450 includes receiving a plurality of images associated with a roof of a structure (depicted by act 452). Method 450 further includes determining at least one attribute of the roof based on at least two images of the plurality of received images (depicted by act 454).

Modifications, additions, or omissions may be made to method 450 without departing from the scope of the present disclosure. For example, the operations of method 450 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

Although the foregoing description contains many specifics, these should not be construed as limiting the scope of the disclosure or of any of the appended claims, but merely as providing information pertinent to some specific embodiments that may fall within the scopes of the disclosure and the appended claims. Features from different embodiments may be employed in combination. In addition, other embodiments of the disclosure may also be devised which lie within the scopes of the disclosure and the appended claims. The scope of the disclosure is, therefore, indicated and limited only by the appended claims and their legal equivalents. All additions, deletions and modifications to the disclosure, as disclosed herein, that fall within the meaning and scopes of the claims are to be embraced by the claims.

What is claimed:

1. A photovoltaic measurement system, comprising:
at least one image capture device configured to capture two or more images of a photovoltaic (PV) installation site; and
an image processing engine communicatively coupled to the at least one image capture device and configured to receive at least two images from the at least one image capture device and determine at least one attribute of a roof at the installation site based on the at least two images.

2. The photovoltaic measurement system of claim 1, wherein the at least one image capture device includes at least one camera.

3. The photovoltaic measurement system of claim 2, wherein the at least one camera comprises at least one panoramic camera.

4. The photovoltaic measurement system of claim 1, wherein the at least one image capture device includes a pole configured to position at least a portion of the at least one image capture device above a plane of the roof.

5. The photovoltaic measurement system of claim 4, the pole comprising an extendable pole including at least one camera mounted thereto.

6. The photovoltaic measurement system of claim 4, the pole comprising a stabilization device.

7. The photovoltaic measurement system of claim 1, the at least one attribute comprising at least one of one or more dimensions of the roof, a height of the roof, a pitch of the roof, orientation of one or more areas of the roof, and solar access of one or more locations on the roof.

8. The photovoltaic system of claim 1, further comprising at least one image capture device configured to capture two or more images of at least one of a roof of a structure and an area surrounding the roof.

9. The photovoltaic system of claim 8, wherein the image processing engine is configured to receive the at least two images from the at least one image capture device via a wireless connection.

10. The photovoltaic system of claim 8, wherein the at least one image capture device includes one of a pole and an un-manned aircraft.

11. A method, comprising:
receiving a plurality of images, each image including a feature associated with a roof of a structure; and
modeling a shape of the roof based upon a position of the feature in a first image of the plurality of images and a position of the feature in at least a second image of the plurality of images.

12. The method of claim 11, wherein receiving a plurality of images comprises receiving a plurality of images from one or more image capture devices.

13. The method of claim 11, wherein modeling a shape of a roof comprises determining at least one attribute of the roof.

14. The method of claim 13, wherein determining at least one attribute of the roof comprises determining at least one of one or more dimensions of the roof, a height of the roof, a pitch of the roof, orientation of one or more areas of the roof, and solar access of the roof.

15. The method of claim 11, further comprising capturing the plurality of images with at least one image capture device including a pole.

16. A method, comprising:
receiving, from at least one camera, a plurality of images associated with a roof of a structure; and
determining at least one attribute of the roof based on at least two images of the plurality of received images.

17. The method of claim 16, wherein determining at least one attribute comprises determining at least one of one or more dimensions of the roof a height of the roof, a pitch of the roof, orientation of one or more areas of the roof, and shading of the roof.

18. The method of claim 16, wherein receiving comprises receiving, from two cameras separated by a known distance, the plurality of images.

19. The method of claim 18, determining a scaling factor for the plurality of images by identifying a linear feature in at least two images of the plurality of images captured by the two cameras.

20. The method of claim 16, further comprising determining a position of the at least one camera based on a feature in the at least two images.
